(19) United States
(12) Patent Application Publication
(10) Pub. No.: US 2026/0333446 A1
(43) Pub. Date: Oct. 22, 2026

(54) ENHANCING A RANDOM ACCESS REPORT WITH TIME INFORMATION

(71) Applicant: Telefonaktiebolaget LM Ericsson (publ), Stockholm (SE)

(72) Inventors: Tahmineh TORABIAN ESFAHANI, SOLLENTUNA (SE); Johan RUNE, LIDINGÖ (SE); Ali PARICHEHREHTEROUJENI, LINKÖPING (SE); Angelo CENTONZA, Granada (ES)

(21) Appl. No.: 19/115,749

(22) PCT Filed: Sep. 8, 2023
(86) PCT No.: PCT/SE2023/050886

§ 371 Date: Mar. 26, 2025

Related U.S. Application Data
(60) Provisional application No. 63/410,317, filed on Sep. 27, 2022.

(51) Int. Cl. H04W 74/0833

(52) U.S. Cl. CPC H04W 74/0833

(57) ABSTRACT

A method according to some embodiments performed by a user equipment (UE) for accessing a wireless communication network includes performing a random access, RA, procedure towards a first network node of the wireless communication network, logging RA related information regarding to RA procedure, the RA related information including time information regarding the RA procedure, and transmitting the RA related information including the time information to a second network node of the wireless communication network. Related methods by a network node are also disclosed.

### TECHNICAL FIELD

The present disclosure relates to wireless communication networks, and in particular to random access procedures in wireless communication networks.

### BACKGROUND

In a wireless communication system, a user equipment performs initial network access using a random access (RA) procedure to a random access channel (RACH) of a cell served by a network node. A contention-based random access procedure that may be performed by a UE is illustrated in FIG. 1. As shown therein, to access a wireless network, a UE initiates a RA procedure by transmitting a RA preamble to the network on the RACH. The network responds with a RA response on the physical downlink shared channel (PDSCH) indicating whether or not the RA attempt was successful. If successful, additional configuration messages are exchanged, after which the UE may communicate with the network.

The configuration (i.e., the RACH parameters) used by the network for RA impacts the user experience and overall network performance. The RACH collision probability, access setup delay, data resuming delay from the UL unsynchronized state, handover delay, transition delay from RRC_INACTIVE, and beam failure recovery delay are all affected by the RACH settings. In addition, performing RACH on the most suitable downlink beam is also important and will avoid unnecessary power ramping and failed RACH attempts. This is beneficial both for the network as well as for the attempting device, as it, ay reduce unnecessary interference in the network and also reduce the delays experienced by users as well as UE energy consumption. In NR, a new feature allows the UE to use dedicated RACH resources depending on a number of factors, such as the service that triggered the RACH procedure.

The setting of RACH parameters depends on a number of factors, such as the uplink inter-cell interference from the Physical Uplink Shared Channel (PUSCH), the RACH load (call arrival rate, HO rate, tracking area update, RRC_INACTIVE transition rate, the request for Other SI, the beam failure recovery, traffic pattern and population under the cell coverage as it affects the UL synchronization states and hence the need to use random access), uplink (UL) and supplementary uplink (SUL) imbalances, PUSCH load, the cubic metric of the preambles allocated to a cell, whether the cell is in high-speed mode or not, and UL and downlink (DL) imbalances.

The goals of RACH optimization are to reduce/minimize access delays for the UEs under the coverage of popular synchronization signal blocks (SSB), to reduce/minimize the delays for the UEs to request the other Sis, to reduce/minimize the imbalance of UEs access delays on uplink (UL) and supplementary uplink (SUL) channel, to reduce/minimize the beam failure recovery delays for the UEs in RRC_CONNECTED and to reduce/minimize the failed/unnecessary RACH attempts on RACH resource before success.

Consequently, the RACH optimization function will attempt to automatically set several parameters related to the performance of RACH.

Automatic RACH parameter settings can be enabled by collecting RACH reports from UEs and by exchange of physical RACH (PRACH) parameters between gNBs. The mechanism and content of information report/exchange for RACH optimization in Long Term Evolution (LTE) could be the baseline whereas taking New Radio (NR) new features. e.g. beam, SUL, etc., into account.

The RACH parameters that can be adjusted include RACH configuration (resource unit allocation), RACH preamble split (among dedicated, group A, group B), RACH backoff parameter value and RACH transmission power control parameters.

At a minimum, RACH optimization is realized by UE providing RACH related information report to the NG RAN node, and by exchange of PRACH configuration of normal UL carrier and SUL carrier between NG RAN node.

In a CU-DU architecture, a gNB-DU should be allowed to report its RACH configuration per cell to the gNB-CU, and the gNB-CU should be allowed to signal the RACH configuration per served cell to neighboring NG RAN nodes. This allows NG-RAN nodes to identify whether RACH configurations of neighboring cells are optimized or whether changes are needed in order to achieve a better RACH coordination between neighboring cells.

Referring to FIG. 2, upon receiving a polling message requesting RACH report, e.g. a UEInformationRequest message, from the NG RAN node (potentially gNB-CU of the current serving cell), a UE reports RACH information within a UEInformationResponse message. The gNB-CU and gNB-DU take into account the RACH report and other node information, to achieve an optimized RACH configuration.

The contents of the RACH information report includes indexes of the SSBs and number of RACH preambles sent on each tried SSB listed in chronological order of attempts, the frequency (NR absolute radio frequency channel numbers, ARFCN) of tried SSBs, the beam quality of each tried SSB (i.e. beam level measurement during RACH attempts such as beam reference signal received power, BRSRP, etc.), an indication whether the selected SSB is above or below the rsrp-ThresholdSSB threshold, an elapsed time from the last measurement prior to the beam selection time, a number of RACH preambles sent on SUL, a number of RACH preambles sent on NUL, and a total number of fallbacks between Contention Based RACH Access (CBRA) and Contention Free RACH Access (CFRA) Contention detection indication.

The report of RACH information when a RA procedure is performed may be requested by the network via the UE Information procedure in RRC in the case where a RACH procedure was successful.

### RA Partitioning

For some features there is a need for the UE to provide an indication to the network in the random access procedure. For example, a UE may need to indicate that the UE is of a certain type or that the UE wants to apply a feature. It is discussed in 3GPP that a UE of reduced capabilities (sometimes called a RedCap UE) may need to indicate to the network during the random access procedure that the UE is a RedCap UE rather than a non-RedCap UE. Another example of such a feature is an indication from the UE whether the UE wants to use a Small Data Transmission (SDT) feature.

To provide such an indication during the random access procedure, it is being discussed that the Random Access resources should be partitioned so that one partition can be dedicated to RedCap UEs and another for non-RedCap UEs.

The system may support several features which require indications during the random access procedure. For example, both support RedCap and SDT. That means that there will be several partitions to indicate combinations of features, such as one partition for non-RedCap UEs which do not want to apply SDT, one partition for non-RedCap UEs which do want to apply SDT, one partition for RedCap UEs which do not want to apply SDT and one partition for RedCap UEs which do want to apply SDT.

A partition of a RA resources may be that there is one time-frequency RA resource which is dedicated to one feature (or combination of features), and another time-frequency RA resources which is dedicated to another feature (or combination of features).

Another possibility is that one set of preambles within a RA resource is dedicated to one feature (or combination of features) and another set of preambles within a RA resource which are dedicated to another feature (or another combination of features).

### PRACH Configuration

The Physical Random-Access Channel (PRACH) is the channel used by the UE to send a RA preamble to the gNB. Prior to initiation of the physical RA procedure, Layer 1 of the UE receives, from higher layers, a configuration of physical random-access channel (PRACH) transmission parameters (PRACH preamble format, time resources, and frequency resources for PRACH transmission), and parameters for determining the root sequences and their cyclic shifts in the PRACH preamble sequence set (index to logical root sequence table, cyclic shift (CS N), and set type (unrestricted, restricted set A, or restricted set B)).

The network configures the set of random-access preamble sequences the UE is allowed to use. The preamble sequences are generated from one or several root Zadoff-Chu sequences with zero correlation zone. In an NR cell, there are up to two sets of up to 64 preamble sequences available where Set 1 corresponds to higher layer PRACH configuration using prach-ConfigurationIndex and prach-FrequencyOffset, and Set 2, if configured, corresponds to higher layer PRACH configuration using prach-ConfigurationIndexHighSpeed and prach-FrequencyOffsetHighSpeed. The set of up to 64 preamble sequences in a cell is found by including first, in the order of increasing cyclic shift, all the available cyclic shifts of a root Zadoff-Chu sequence with the logical index rootSequenceIndexHighSpeed (for Set 2, if configured) or with the logical index RACH_ROOT_SEQUENCE (for Set 1), where both rootSequenceIndexHighSpeed (if configured) and RACH_ROOT_SEQUENCE are broadcasted as part of the System Information. Additional preamble sequences, in case the configured number of allowed preamble sequences cannot be generated from a single root Zadoff-Chu sequence, are obtained from the root sequences with the consecutive logical indexes until all the preamble sequences are found. The cell common RACH configuration is broadcast in SIB1 to the UEs.

To prevent PRACH collision (caused by overlapping PRACH configuration with a neighbor cell) and/or PRACH confusion (caused by overlapping PRACH configuration between neighbor cells), two adjoining cells should have different RACH sequence indices.

### SUMMARY

A method according to some embodiments performed by a user equipment (UE) for accessing a wireless communication network includes performing a random access, RA, procedure towards a first network node of the wireless communication network, logging RA related information regarding to RA procedure, the RA related information including time information regarding the RA procedure, and transmitting the RA related information including the time information to a second network node of the wireless communication network.

The information may include an indication of an elapsed time between the time the RA related information was logged until the time the RA related information was transmitted to the second network node.

The information may include an indication of an elapsed time between the time the RA procedure was performed until the time the RA related information was transmitted to the second network node.

The elapsed time may be indicated as a number of minutes, a number of seconds, a number of milliseconds, a number of frames (e.g. radio frames or system frames), a number of subframes, a number of slots, a number of hours and a number of minutes, a number of hours and a number of minutes and a number of seconds, a number of minutes and a number of seconds, a number of seconds and a number of milliseconds, a number of minuets and a number of seconds and a number of milliseconds, or any combination of any of the above.

The time information may include a timestamp that indicates when the RA related information was logged.

The information may include a timestamp that indicates when the RA procedure was performed.

The timestamp may be expressed as one of, or a combination of a UTC indication, a GNSS time indication, e.g. a GPS time indication, a Hyper-SFN (H-SFN) and a SFN, a H-SFN, a SFN and a subframe number, a H-SFN, a SFN and a slot number, a H-SFN, a SFN, a slot number and a symbol number.

The time information may include a timestamp that indicates a point in time when information related to the RA procedure was logged, the initiation of the RA procedure which the RA related information pertains to, a RA attempt, each RA attempt in the RA procedure which the RA related information pertains to, an end of the RA procedure, a last random access preamble transmission in the RA procedure, the reception of a random access response, RAR, or MsgB in a successful RA attempt, or the reception of a successful contention resolution indication.

Transmitting the RA related information including the time information to the second network node may include including the time information in a RA-InformationCommon-r16 information element.

Transmitting the RA related information to the second network node may be performed in response to a request received from the second network node, wherein the request indicates that the time information should be included in the RA related information.

The first network node and the second network node are the same network node.

The method may further include providing user data, and forwarding the user data to a host via transmission to the second network node.

A user equipment according to some embodiments includes a processing circuitry, a communication interface coupled to the processing circuitry, and a memory coupled to the processing circuitry. The memory includes computer readable program instructions that, when executed by the processing circuitry, cause the user equipment to perform operations including performing a random access, RA, procedure towards a first network node of a wireless communication network, logging RA related information regarding to RA procedure, the RA related information including time information regarding the RA procedure, and transmitting the RA related information including the time information to a second network node of the wireless communication network.

A method according to some embodiments performed by a network node of a wireless communication network includes transmitting to a UE, a request for a random access, RA, report from the UE, receiving the RA report, wherein the RA report includes time information regarding a RA procedure referenced in the RA report, determining a time when the RA procedure referenced in the report was performed based on the time information, identifying an RA configuration that was in effect at the time when the RA procedure referenced in the RA report was performed based on the time when the RA procedure referenced in the RA report was performed, and adjusting an RA configuration parameter based on the RA report.

The time information may include an indication of an elapsed time between a time when information relating to the RA procedure was logged until a time the RA report was transmitted to the network node.

The time information may include an indication of an elapsed time between a time the RA procedure was performed until a time the RA report was transmitted to the second network node.

The elapsed time may be indicated as a number of minutes, a number of seconds, a number of milliseconds, a number of frames (e.g. radio frames or system frames), a number of subframes, a number of slots, a number of hours and a number of minutes, a number of hours and a number of minutes and a number of seconds, a number of minutes and a number of seconds, a number of seconds and a number of milliseconds, a number of minuets and a number of seconds and a number of milliseconds, or any combination of any of the above.

The time information may include a timestamp that indicates a time when information relating to the RA procedure was logged.

The time information may include a timestamp that indicates a time when the RA procedure was performed.

The timestamp may be expressed as one of, or a combination of a UTC indication, a GNSS time indication, e.g. a GPS time indication, a Hyper-SFN (H-SFN) and a SFN, a H-SFN, a SFN and a subframe number, a H-SFN, a SFN and a slot number, a H-SFN, a SFN, a slot number and a symbol number.

The time information may include a timestamp that indicates a point in time when information related to the RA procedure was logged, the initiation of the RA procedure which the RA related information pertains to, a RA attempt, each RA attempt in the RA procedure which the RA related information pertains to, an end of the RA procedure, a last random access preamble transmission in the RA procedure, the reception of a random access response, RAR, or MsgB in a successful RA attempt, or the reception of a successful contention resolution indication.

The time information may be included in a RA-InformationCommon-r16 information element.

The method may further include transmitting a request for the RA report to the UE, wherein the request indicates that the time information should be included in the RA report.

The RA configuration parameter may include one or more of: resource unit allocation, random access channel, RACH, preamble split, RACH backoff parameter value, physical RACH, PRACH, preamble format, time resources for PRACH transmission, frequency resources for PRACH transmission, and parameters for determining root sequences and their cyclic shifts in PRACH preamble sequence set.

A network node according to some embodiments includes a processing circuitry, a communication interface coupled to the processing circuitry, and a memory coupled to the processing circuitry. The memory includes computer readable program instructions that, when executed by the processing circuitry, cause the user equipment to perform operations including transmitting to a UE a request for a random access, RA, report from the UE, receiving the RA report, wherein the RA report includes time information regarding a RA procedure referenced in the RA report, determining a time when the RA procedure referenced in the report was performed based on the time information, identifying an RA configuration that was in effect at the time when the RA procedure referenced in the RA report was performed based on the time when the RA procedure referenced in the RA report was performed, and adjusting an RA configuration parameter based on the RA report.

A method performed by a first network node of a wireless communication network according to some embodiments includes transmitting to a user equipment, UE, a request for a random access, RA, report from the UE, receiving the RA report, wherein the RA report includes time information regarding a RA procedure referenced in the RA report, identifying a second network node of the wireless communication network toward which the RA procedure referenced in the RA report was performed, and transmitting RA related information from the RA report to the second network node, wherein the RA related information includes the time information regarding the RA procedure referenced in the RA report.

A network node according to some embodiments includes a processing circuitry, a communication interface coupled to the processing circuitry, and a memory coupled to the processing circuitry. The memory includes computer readable program instructions that, when executed by the processing circuitry, cause the user equipment to perform operations including transmitting to a UE a request for a random access, RA, report from the UE, receiving the RA report, wherein the RA report includes time information regarding a RA procedure referenced in the RA report, identifying a second network node of the wireless communication network toward which the RA procedure referenced in the RA report was performed, and transmitting RA related information from the RA report to the second network node, wherein the RA related information includes the time information regarding the RA procedure referenced in the RA report.

A method performed by a second network node of a wireless communication network according to some embodiments includes receiving, from a first network node of the wireless communication network, random access, RA, related information regarding a RA procedure performed toward the second network node by a user equipment, UE, wherein the RA related information includes time information regarding the RA procedure performed toward the second network node, identifying an RA configuration that was in effect at the time when the RA procedure performed toward the second network node was performed based on the time information, and adjusting an RA configuration parameter based on the RA related information.

A network node according to some embodiments includes a processing circuitry, a communication interface coupled to the processing circuitry, and a memory coupled to the processing circuitry. The memory includes computer readable program instructions that, when executed by the processing circuitry, cause the user equipment to perform operations including receiving, from a first network node of the wireless communication network, random access, RA, related information regarding a RA procedure performed toward the second network node by a user equipment, UE, wherein the RA related information includes time information regarding the RA procedure performed toward the second network node, identifying an RA configuration that was in effect at the time when the RA procedure performed toward the second network node was performed based on the time information, and adjusting an RA configuration parameter based on the RA related information.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a random access procedure.

FIG. 2 illustrates a UE information request procedure.

FIG. 3 illustrates a random access logging procedure.

FIG. 4 illustrates a random access procedure according to some embodiments.

FIG. 5 illustrates operations of a user equipment according to some embodiments.

FIGS. 6 to 8 illustrate operations of a network node according to some embodiments.

FIG. 9 illustrates operations of a user equipment according to some embodiments.

FIG. 10 shows an example of a communication system in accordance with some embodiments.

FIG. 11 shows a UE in accordance with some embodiments.

FIG. 12 shows a network node in accordance with some embodiments.

FIG. 13 is a block diagram of a host.

FIG. 14 is a block diagram illustrating a virtualization environment in which functions implemented by some embodiments may be virtualized.

FIG. 15 shows a communication diagram of a host communicating via a network node with a UE over a partially wireless connection in accordance with some embodiments.

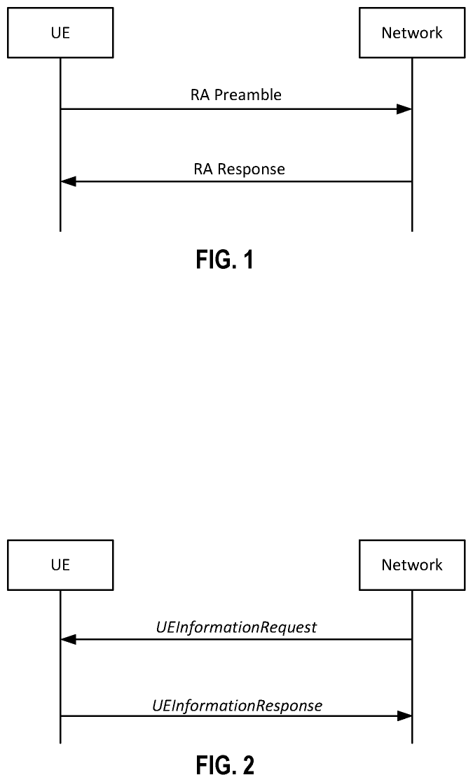

### DESCRIPTION OF EMBODIMENTS

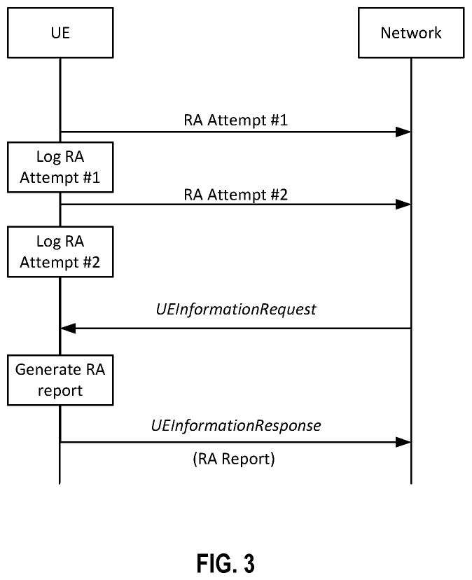

As noted above, a UE is configured by the network to use RA resources having a particular configuration. In the current RA procedure, the UE logs an RA report upon successful/failure execution of an RA procedure. The RA report may be retrieved by the network at a later time. An example of a RA logging procedure is shown in FIG. 3. As shown therein, a UE makes a RA attempt (RA Attempt #1). After RA Attempt #1, the UE generates a log record of the RA attempt. The log record includes RA-related information, such as whether or not the RA attempt was successful, indexes of the SSBs and number of RACH preambles sent on each tried SSB, the frequency of tried SSBs, the beam quality of each tried SSB, an indication whether the selected SSB is above or below the rsrp-ThresholdSSB threshold, an elapsed time from the last measurement prior to the beam selection time, a number of RACH preambles sent on SUL, a number of RACH preambles sent on NUL, and a total number of fallbacks between CBRA and CFRA.

In the example shown in FIG. 3, the UE subsequently makes a second RA attempt (RA Attempt #2), and generates a log record of the second RA attempt after it is complete. At a later time, the network may request that the UE provide a RA report by sending the UE a UEInformationRequest message. The UE then generates a RA report including the RA-related information regarding RA Attempt #1 and RA Attempt #2, and transmits the RA report to the network in a UEInformationResponse message.

RA resources are expected to be partitioned for different use cases (e.g., RedCap, Small data enhancements, Slicing). A UE may use a specific part of the RA resource depending on what the network configures based on the UE's capabilities and UE's current configuration. Moreover, the RA resources may be partitioned in different RA resource allocation that could be changed over time. Currently, there are discussions regarding RACH partitioning for RACH report enhancements.

A UE may be configured with RA resources (that could be allocated to a specific RA partition), and it could perform RACH access on such resources triggered by one of the features associated to the RACH partition. The UE logs the RA related information at the execution of RA procedure. However, the network may change the RA configuration dynamically over time, such as for network optimization. Thus, at the time the network fetches an RA report containing logged RA information, the UE may have a different RACH resource configuration than it had when the RA attempts reflected in the RA report were made.

In other words, RA related information is logged by the UE for later reporting to the network. Since the network is not aware of the time when an RA event associated to a RA report reported by the UE occurred, the network may analyze the obtained RA report and compare it with the existing RA configuration. This may lead to wrong RA resource configuration adjustments, because the network may deduce from the RA reports that there is a need to optimize the RACH resource configuration, while such optimization may not be needed as the report refers to an event that happened in the past and for which a different RA configuration was used.

Certain aspects of the disclosure and their embodiments may provide solutions to these or other challenges. Some embodiments described herein provide a method performed by the UE to collect and include information indicating the time elapsed from when the RA related information is logged until it is reported in RA report to the network. With this information, the UE provides a log of the time when the RACH access event triggering the creation of the RA Report happened. This information can enable the network to deduce the RA resource configuration in place at the time the RA Report was created.

In the following description, the terms “network node” and “radio access network, RAN, node” are used interchangeably to refer to a node of a wireless communication network, such as an eNodeB (eNB) or a gNodeB (gNB).

Some further embodiments provide a method performed by a first RAN node that fetches an RA report from a UE, where the RA report includes a log of an RA attempt to a second RAN node. The RA report contains information indicating when the RA related information contained in the RA report was logged. The first RAN node forwards the RA report to the second RAN node. In connection with this, the RAN node computes and sends the time elapsed between fetching the RA report from the UE and the time of sending the RA report to the second RAN node.

On the basis of such information received from the UE, the methods herein allow the network to determine the associated RA resource configuration at the time that RA is logged.

Accordingly, some embodiments provide that a UE logs the time elapsed between logging an RA report and sending the RA report to a network node.

In some embodiments, a UE logs the time elapsed between execution of an RA procedure for which the RA report is logged and sends the RA report to the network node.

In some embodiments, the first RAN node that fetches the RA report computes the time elapsed between fetching the RA report and sending the RA report to the second RAN nodes in which the actual corresponding RA procedure was performed.

The second RAN node in which the actual RA procedure was performed determines the point in time at which the RA procedure was performed and determines the RA partitioning configuration at that time.

The second RAN node uses the RA report and the corresponding RA partitioning configuration at the time of RA execution to modify the RA partitioning configuration. The second RAN node may use the RA report and the corresponding RA partitioning configuration at the time of RA execution to modify the RA partitioning configuration and/or to avoid modifications of the RA resource configurations addressing issues that were already corrected in the past.

Certain embodiments may provide one or more of the following technical advantage(s). By having information by which the network can determine the time at which an RA attempt reflected in an RA log occurred, the network can identify the RA configuration to which an RA report is associated. This may attempt the network to determine more appropriate RA resource configuration adjustments.

Some of the embodiments contemplated herein will now be described more fully with reference to the accompanying drawings. Embodiments are provided by way of example to convey the scope of the subject matter to those skilled in the art.

UE based method to log the RA partition information in the RA report

As described above, upon performing an RA procedure, the UE logs, and subsequently provides to the network a report about the RA procedure.

In some embodiments, a UE logs time information associated with a logged RA attempt. This time information may be included in an RA report that references the RA attempt, and may allow the network to determine the RA resource configuration in use at the time when the UE triggered the RACH access procedure and used the associated RA resources that are reflected in the RA report.

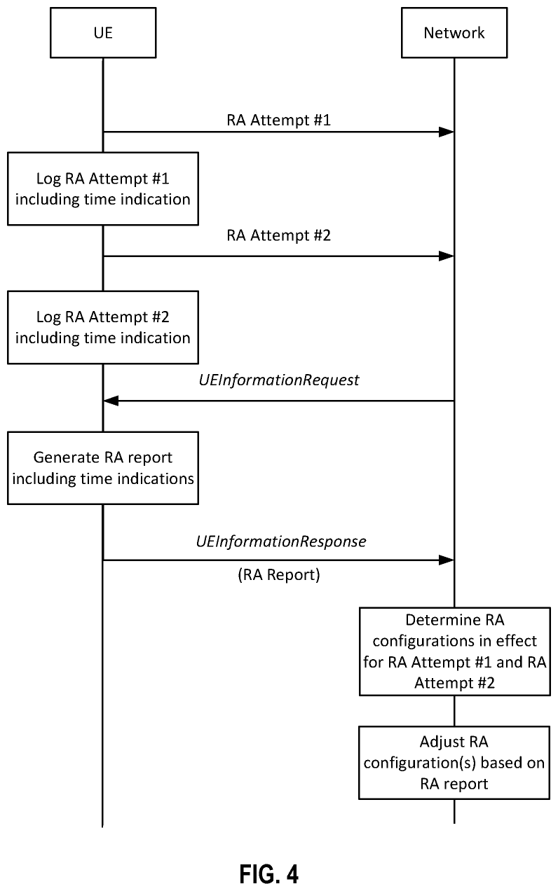

An example of a procedure according to some embodiments is illustrated in FIG. 4. As shown therein, a UE may perform a first RA attempt (RA Attempt #1) toward a network node (e.g., a first network node). In connection with the first RA attempt, the UE logs time information associated with the first RA attempt. The time information that the UE may log is described in more detail below.

The UE may then perform a second RA attempt (RA Attempt #2) toward the first network node or toward a different network node. In connection with the second RA attempt, the UE logs time information associated with the second RA attempt.

Subsequently, the UE receives a request for an RA report from the network (e.g., a UEInformationRequest indicating that an RA report is requested). The request may be received from the first network node or a different network node. The UE prepares an RA report including RA related information about the first and second RA attempts. The RA related information in the RA report includes the time information regarding the first and second RA attempts. The UE then transmits the RA report to the requesting node.

Based on the time information in the RA report, the network determines the RA configurations that were in effect at the time RA Attempt #1 and RA Attempt #2 were performed. The network may then adjust the RA configuration for one or more cells based on the RA report, using the awareness of which RA configurations were in effect at the time of the RA attempts referenced in the RA report.

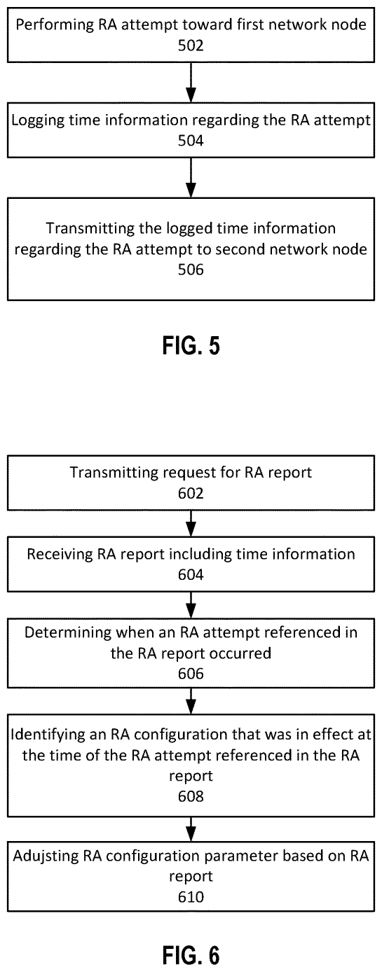

Operations of a UE according to some embodiments are illustrated in FIG. 5. As shown therein, a UE performs an RA attempt toward a first network node (block 502). In connection with the RA attempt, the UE logs time information regarding the RA attempt (block 504). The UE transmits the logged time information regarding the RA attempt to a second network node (block). The first network node and the second network node may be different nodes or may be the same node. The logged time information may be included in an RA report that references the RA attempt. The RA report may be transmitted to the second network node in response to a request by the second network node. The request may include a UEInformationRequest message.

Operations of a network node according to some embodiments are illustrated in FIG. 6. As shown therein, a network node may transmit a request to a UE to provide a RA report (block 602). The network node receives a RA report from the UE (block 604). The RA report includes time information regarding an RA attempt referenced in the RA report. Based on the time information in the RA report, the network node determines when the RA attempt referenced in the RA report occurred (block 606). The network node may identify the RA configuration that was in effect at the time of the RA attempt based on when the RA attempt occurred (block 608). The network may then adjust an RA configuration parameter based on the RA report (block 610).

According to some embodiments, a UE collects and includes in the RA report an indication of the time at which the RA procedure occurred. In some embodiments, an indication is provided of the elapsed between the time the RA related information was logged until the time the RA report is transmitted to the network.

In some further embodiments, a UE collects and includes in a RA report a time elapsed since the occurrence of the RA procedure referenced in an RA report until the RA report is transmitted to the network.

In some embodiments, a UE includes the time that has elapsed since the UE executed an RA procedure in accordance with the RA resource configuration from a first network node until this RA related information is reported to a second network node in the form of a RA Report. The second network node may be the same network node as the first network node or a different network node. When the first network node and the second network node are different nodes, the second network node may forward the received report, or relevant parts of the report, to the first network node. In other words, the UE may report in the RA Report one or more indications that allow the network to understand the RA resource configuration at the moment RA related information is logged. Therefore, the network may analyze the RA report related information associated to the RA resource configuration used by the UE at moment the RA procedure occurred, instead of erroneously associating the content of the RA report to a current RA resource configuration.

In further embodiments, a UE includes the time that has elapsed since the UE executed an RA procedure in accordance with the RA resource configuration from the first network node until the RA related information is reported to the same network node. In particular, the RA report may be associated to a RACH access performed at the same node to which the RA report is transmitted by the UE.

In further embodiments, using dynamic RA resource configuration, a network node may request the UE to log the time elapsed since the performed RA procedure until reporting it to the network in a RRC message e.g., a RRCReconfigurationComplete message.

In some embodiments, a UE may log the elapsed time since information related to an RA procedure was logged, or the elapsed time since the execution of an RA procedure for which RA related information is logged, until the time when the RA Report is transmitted to the network. The UE may do so either because a network node (e.g. the first network node) has configured it to do so (e.g. using an RRCReconfiguration message), or based on a predetermined configuration.

Subsequently, when the UE receives from a network node a request to send an RA report containing the logged information related to the RA procedure, the UE may or may not include the information about the elapsed time in the RA report that it sends to the requesting network node. The decision whether to include the information about the elapsed time in the RA report is based on an indication in the message from the network node that requests the UE to send the RA report, e.g. a UEInformationRequest message. That is, a network node, e.g. a gNB, that requests22 a UE to send a RA report, e.g. via a UEInformationRequest message, may include in the request message an indication of whether the UE should include the information about the elapsed time in the RA report.

In various embodiments, the elapsed time may be expressed as a number of minutes, a number of seconds, a number of milliseconds, a number of frames (e.g. radio frames or system frames), a number of subframes, a number of slots, a number of hours and a number of minutes, a number of hours and a number of minutes and a number of seconds, a number of minutes and a number of seconds, a number of seconds and a number of milliseconds, a number of minuets and a number of seconds and a number of milliseconds, or any combination of any of the above.

In some embodiments, the time related information that a UE logs and includes in an RA report is an indication of a point in time, e.g. a timestamp, rather than an indication of an elapsed time. The timestamp may indicate when the RA related information was logged or when the RA procedure was performed. Such a timestamp or time indication may be expressed as one of, or a combination of a UTC indication, a GNSS time indication, e.g. a GPS time indication, a Hyper-SFN (H-SFN) and a SFN, a H-SFN, a SFN and a subframe number, a H-SFN, a SFN and a slot number, a H-SFN, a SFN, a slot number and a symbol number.

In some embodiments, the timestamp may include a UTC indication (or other time indication such as a GNSS time indication e.g. a GPS time indication) which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN.

In some embodiments, the timestamp may include a UTC indication (or other time indication such as a GNSS time indication e.g. a GPS time indication) which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a subframe number.

In some embodiments, the timestamp may include a UTC indication (or other time indication such as a GNSS time indication e.g. a GPS time indication) which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a slot number.

In some embodiments, the timestamp may include a UTC indication (or other time indication such as a GNSS time indication e.g. a GPS time indication) which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a subframe number and a slot number.

In some embodiments, the timestamp may include a UTC indication (or other time indication such as a GNSS time indication e.g. a GPS time indication) which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a slot number and a symbol number.

In some embodiments, the timestamp may include a UTC indication (or other time indication such as a GNSS time indication e.g. a GPS time indication) which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a subframe number and a slot number and a symbol number.

The UTC or other time indication (e.g. GNSS time indication) in the above options may in some embodiments be replaced by an indication of elapsed time. That is, the timestamp or time indication may be expressed as one of, or a combination of an indication of elapsed time which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN, an indication of elapsed time which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a subframe number, an indication of elapsed time which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a slot number, an indication of elapsed time which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a subframe number and a slot number, an indication of elapsed time which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a slot number and a symbol number, and/or an indication of elapsed time which is sufficiently accurate to point out a certain SFN cycle (e.g. with a maximum error of X seconds or a low probability of an error greater than X seconds, where X may be e.g. 5 seconds, 6 seconds, 7 seconds, 8 seconds, 9 seconds or 10 seconds) and an SFN and a subframe number and a slot number and a symbol number.

In various embodiments, the time related indication, e.g. the timestamp or the starting point of an indicated elapsed time, may be associated with the point in time when information related to a RA procedure was logged, the initiation of the RA procedure which the logged and reported RA related information pertains to, a RA attempt, each RA attempt in the RA procedure which the logged and reported RA related information pertains to (e.g. one timestamp or elapsed time indication for each RA attempt), the end of the RA procedure, the last random access preamble transmission (i.e. the last RA attempt) in the RA procedure, the reception of a RAR or MsgB in a successful RA attempt, or the reception of a successful contention resolution indication.

In one embodiment, the time related information may be included in the RA-InformationCommon-r16 IE, which means that it will not only be included in the RA report (i.e. the RA-Report-r16 IE in the UEInformationResponse message), but also in the RLF report (i.e. the RLF-Report-r16 IE in the UEInformationResponse message).

An example of how this can be included in the RRC specification, is given in

### Appendix A.

Including time information in the RA report as described above may be useful to indicate to the network how long ago a reported RA procedure was performed. However, as previously described, a UE may send an RA report to a RAN node other than the RAN node controlling the cell in which the RA procedure referenced in the RA report was performed. In that case, the RAN node that receives the RA report may forward the RA report to the RAN node that controls the cell in which the reported RA procedure was performed (and which cell ID is indicated in the RA report).

Because of the processing involved when the network node receives, analyzes and forwards an RA report, there is a potential for additional delay (or additional elapsed time) in the network node that receives and forwards the RA report. This additional elapsed time is not accounted for in the elapsed time indicated in the RA report.

Sometimes the delay in the RAN node that receives and forwards the RA report may be non-negligible, such that the RAN node analyzing the report (e.g. the RAN node to which the RA report is forwarded, i.e. the RAN node controlling the cell in which the reported RA procedure was performed) may do that in view of the incorrect RA configuration in the concerned cell, because the elapsed time indicated in the RA report itself is shorter than the actual elapsed time due to the additional delay incurred in the RAN node receiving and forwarding the RA report. That is, the content of the RA report may be older than implied by the elapsed time in the RA report. Thus, the RA procedure the information in the RA report pertains to may have occurred a longer time ago than implied by the elapsed time indicated in the RA report.

Non-negligible delay may arise in the RAN node that receives and forwards the RA report for a number of reasons. For example, the RAN node's resources, e.g. processing resources, may be loaded, and fully occupied, by tasks with higher priority. In addition, there may be no Xn (or X2) interface between the RAN node receiving the RA report and the RAN node to which the RA report will be forwarded (and which will analyze the RA report). This interface has to be setup before the RA report (or the relevant parts of it) can be forwarded. Also, the RAN node to which the RA report (or relevant parts of it) should be forwarded may be undergoing a restart, or the Xn (or X2) interface between the RAN node and the RAN node to which the RA report will be forwarded, or any interface used to carry out such forwarding, may be temporarily unavailable.

For example, there may be a problem with the Xn (or X2) interface between the RAN node and the RAN node to which the RA report will be forwarded, or any interface used to carry out such forwarding. The problem may involve, for example, overload, packet loss in the transport network, transport network protocol errors, and/or restart of a router or switch or other forwarding node in the transport network.

To address this problem, the RAN node that receives and forwards the RA report (herein denoted the first network node) may also determine a node internal delay and send information about the node internal delay to the same RAN node as the RA report is sent to. The node internal delay refers to the time between receiving the RA report from the UE and sending the RA report to the RAN node controlling the cell in which the reported RA procedure was performed (herein denoted as the second network node).

There are various options for how to represent the information related to the node internal delay and how to send it to the other RAN node. For example, the first network node may add its internal delay to the elapsed time in the RA report. In some embodiments, the first network node may add its internal delay to the elapsed time indicated in the RA report before forwarding/sending the elapsed time indication to the RAN node towards which the RA procedure in the RA report was performed.

In some embodiments, the first network node may include its internal delay in the RA report.

In some embodiments, the first network node extracts a part of the information in the RA report and forwards it to the second network node. The first network node may include its internal delay in the information extracted from the received RA report that the is to be forwarded/sent to the second network node.

In some embodiments, the first network node may include its internal delay as a separate IE (e.g. at the XnAP level or X2AP level) in the XnAP (or X2AP) message used to forward/send the received RA report (or relevant part of the RA report) to the second network node. This message may be the ACCESS AND MOBILITY INDICATION XnAP message.

The internal delay may be indicated as a number of seconds, a number of milliseconds or a number of seconds combined with a number of milliseconds.

Instead of indicating an internal delay, the first network node may indicate a timestamp of the time when the first network node received the RA report. Indicating a timestamp instead of a delay may have the potential advantage that it captures delays that occur after the XnAP (or X2AP) message used to forward the information has been created and passed to lower layers for transmission, e.g. delays caused by transport network problems or temporary unavailability of the Xn (or X2) interface. This timestamp may e.g. be a UTC or a GNSS time indication. If the cell the first network node received the RA report in is synchronized with the cell of the second network node the reported RA procedure was performed in, then the timestamp can be realized as any of a system frame number (SFN), a subframe number, a slot number, a SFN and a slot number, a slot number and a symbol number, a SFN, a slot number and a symbol number, a H-SFN and a SFN, a H-SFN, a SFN and a subframe number, a H-SFN, a SFN and a slot number, and/or a H-SFN, a SFN, a slot number and a symbol number.

In some embodiments, the first network node may add, in addition to its internal delay in forwarding the RA report, an estimation of the one way transmission delay over the interface used to signal the RA Report to the RAN node where the RACH Access was carried out. The latter would provide the second node with an even more accurate estimate of the overall delay from the time the RA Report or RACH event occurred to the time the associated RA Report was received at the second network node.

Accordingly, some embodiments provide a method performed by a first network node to forward RA related information received from a UE to a second network node. The RA related information includes information related to a RA procedure the UE has performed. The RA related information may include an internal node delay at the first network node. The RA related of information may be part of (e.g. a subset of) a larger set of information, and may include an RA report or portions of an RA report.

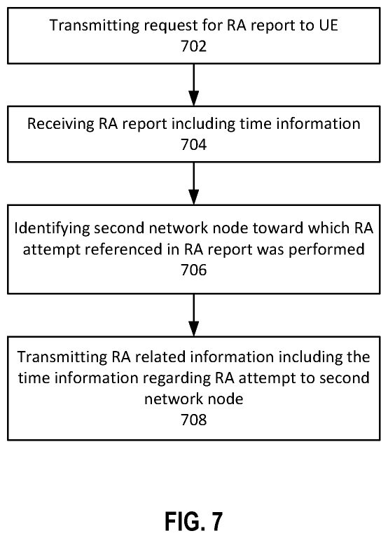

For example, operations of a first network node according to some embodiments are illustrated in FIG. 7. As shown therein, a first network node may transmit a request for a RA report to a UE (block 702). The first network node then receives from the UE an RA report containing time information relating to an RA attempt referenced in the RA report, such as elapsed time or a timestamp (block 704).

Based on the RA report, the first network node may identify a second network node toward which the RA attempt referenced in the RA report was performed (block 706). The first network node may transmit RA related information regarding the RA attempt referenced in the RA report to the second network node (block 708).

The method may further include fetching or receiving the RA related information, e.g., RA Report, from the UE.

The first network node may identify the second network node (i.e. the node toward which the RA procedure referenced in the RA related information was performed) by means of one or more cell identities contained in the RA related information.

In some embodiments, the first network node may determine a node internal delay, i.e., additional processing delay associated with receiving and forwarding the RA related information to the second network node. The first network node may send the second network node an indication of the additional processing delay. The indication of the additional processing delay may be transmitted within or together with the RA related information transmitted to the second network node.

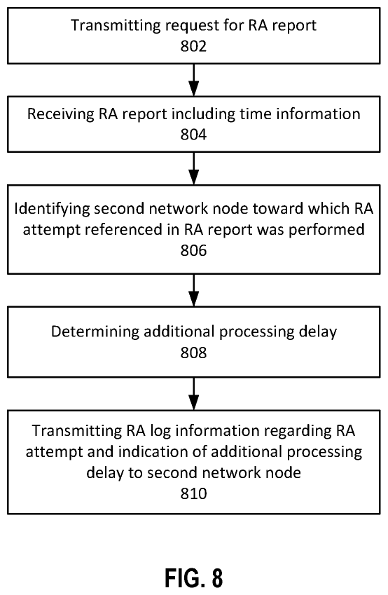

FIG. 8 illustrates operations according to some embodiments. In particular, as shown in FIG. 8, a first network node may transmit a request for a RA report to a UE (block 802). The first network node then receives from the UE an RA report containing time information relating to an RA attempt referenced in the RA report, such as elapsed time or a timestamp (block 804).

Based on the RA report, the first network node may identify a second network node toward which the RA attempt referenced in the RA report was performed (block 806).

The first network node may determine an additional processing delay associated with receiving and forwarding the RA related information to the second network node (block 808).

The first network node may then transmit RA related information regarding the RA attempt referenced in the RA report to the second network node (block 810). The RA related information may include an indication of an additional processing delay in the first network node.

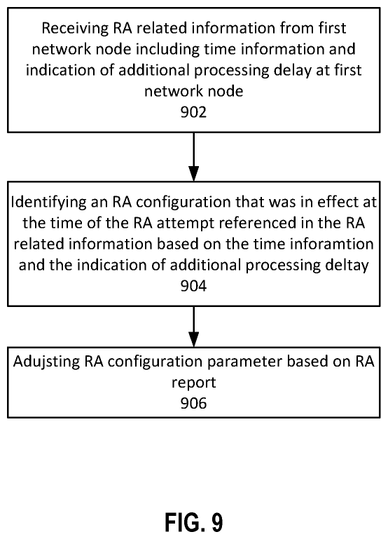

Operations of a second network node according to some embodiments are illustrated in FIG. 9. As shown therein, a second network node receives RA related information from a first network node (block 902). The RA related information relates to an RA attempt performed by a UE at the second network node, and includes time information regarding the RA attempt. The second network node also receives an indication of an additional processing delay at the first network node.

The second network node identifies an RA configuration that was in effect at the time of the RA attempt based on the time information included in the RA related information and based on the indication of the additional processing delay at the first network node (block 904). The second network node then adjusts an RA configuration parameter based on the RA related information (block 906).

In one embodiment, the RA related information is sent in a new container inserted in an XnAP ACCESS AND MOBILITY INDICATION message.

In another embodiment, the RA related information is sent with the RACH Report Container IE within an XnAP ACCESS AND MOBILITY INDICATION message.

Some embodiments provide a method performed by a second network node (RAN node) to receive the RA related information from the first network node and analyze the RA related information. The second network node may optionally also receive an indication of an additional processing delay in the first network node as well as an estimate of a signalling delay over an interface over which the RA Report is propagated. The estimate of signalling delay may either be included in the RA related information or together with the RA related information. The method may include receiving the RA related information from the first network node. An additional processing delay associated with the first network node may be included in the RA related information or together with the RA related information.

In one embodiment, the RA related information is received in a new container inserted in an XnAP ACCESS AND MOBILITY INDICATION message, wherein the second network node's internal delay optionally may be included in the RA related information or may be received together with the RA related information.

In another embodiment, the RA related information is received with the RACH Report Container IE within an XnAP ACCESS AND MOBILITY INDICATION message, wherein the second network node's internal delay optionally may be included in the RA related information or may be received together with the RA related information.

Based on the timing information provided by the UE (in the RA report e.g., timeSinceRA-r18) and optionally the timing information provided by the first network node (i.e. the node internal delay, e.g., Time Elapsed Since Fetching), the second network node may determine the point in time at which the RA procedure the RA related information pertains to was actually performed.

The second network node may determine an RA partitioning configuration that was in effect at the time of the RA procedure referenced in the RA related information.

The second network node may analyze the RA related information associated to the RA resource configuration at the time the RA procedure was performed and may adjust or optimize the RA resource configurations based on the RA related information.

Including the elapsed time in the RA report, as described above, is useful to indicate to the network how long ago a reported RA procedure was performed. However, in the case where the UE sends the RA report to another RAN node (e.g. gNB or eNB) than the RAN node that controls the cell the reported RA procedure was performed in, the RAN node receiving the RA report will forward the RA report to the RAN node which controls the cell in which the reported RA procedure was performed (and which cell ID is indicated in the RA report). There is thus a potential for additional delay (or additional elapsed time) in the RAN node receiving and forwarding the RA report, and this additional elapsed time is not accounted for in the elapsed time indicated in the RA report.

Sometimes the delay in the RAN node that receives and forwards the RA report may be non-negligible, such that the RAN node analyzing the report (e.g. the RAN node to which the RA report is forwarded, i.e. the RAN node controlling the cell in which the reported RA procedure was performed) may do that in view of the incorrect RA configuration in the concerned cell, because the elapsed time indicated in the RA report itself is shorter than the actual elapsed time due to the additional delay incurred in the RAN node receiving and forwarding the RA report, i.e. the content of the RA report is older than implied by the elapsed time in the RA report, or, in other words, the RA procedure the information in the RA report pertains to occurred longer ago than implied by the elapsed time indicated in the RA report.

An example implementation is shown in Appendix B.

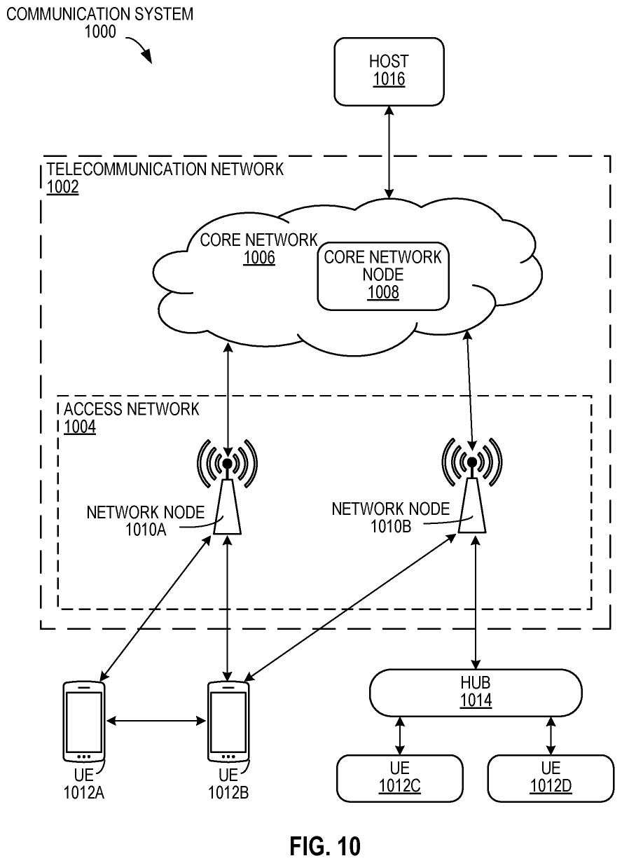

FIG. 10 shows an example of a communication system 1000 in 1accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub-that is, a hub whose primary function is to route communications to/from the UEs from/to the network node 1010b. In other embodiments, the hub 1014 may be a non-dedicated hub-that is, a device which is capable of operating to route communications between the UEs and network node 1010b, but which is additionally capable of operating as a communication start and/or end point for certain data channels.

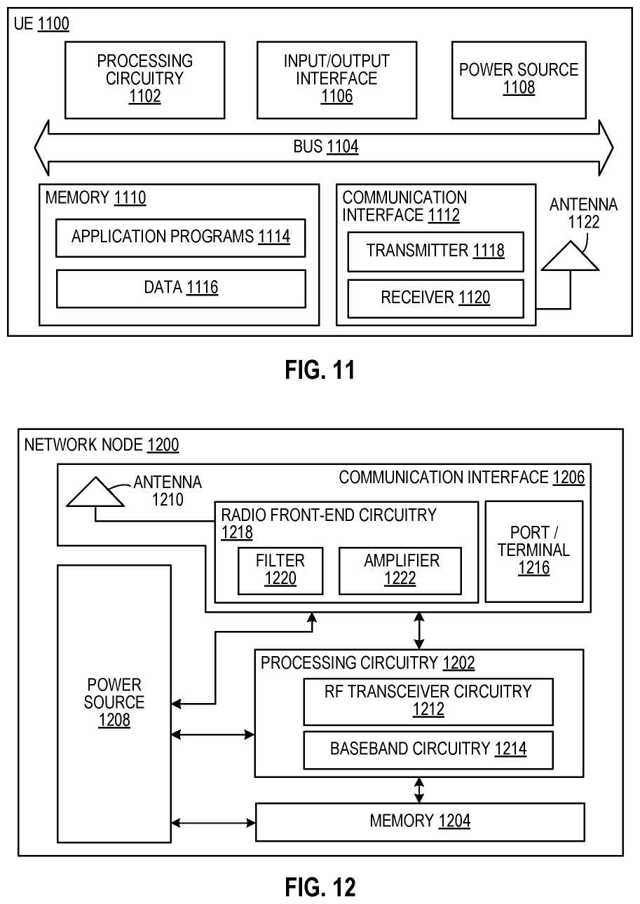

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

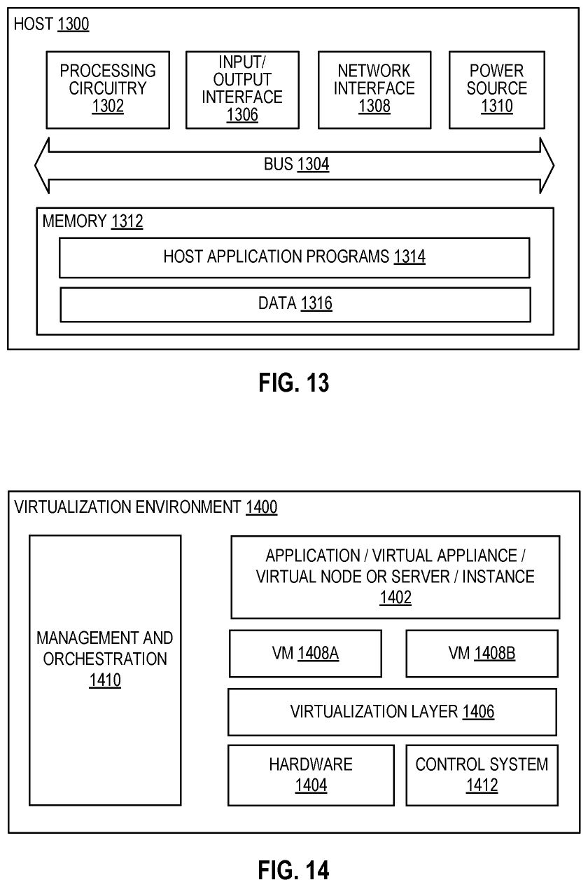

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

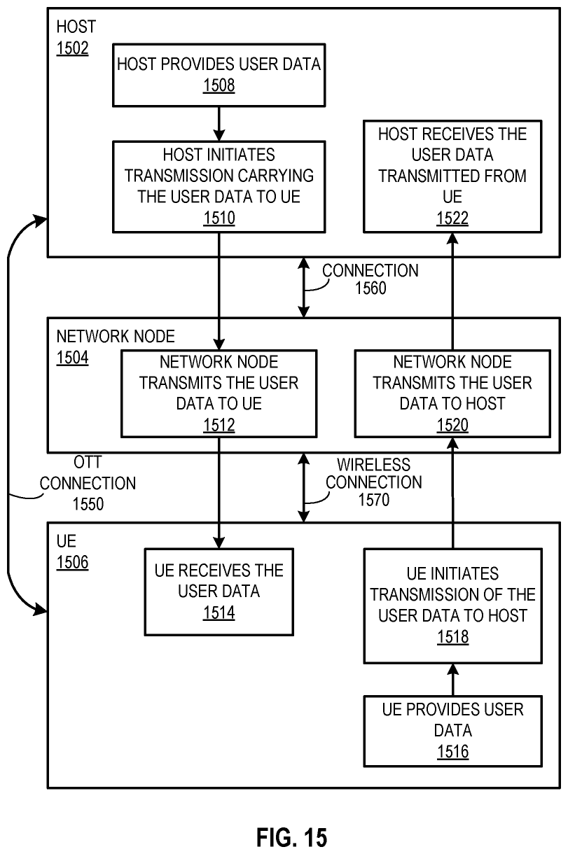

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve the efficiency and speed of RA procedures and thereby provide benefits such as reduced user waiting times, better responsiveness and extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein.

Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE, for accessing a wireless communication network, the method comprising:
performing a random access, RA, procedure towards a first network node of the wireless communication network;
logging RA related information regarding to RA procedure, the RA related information comprising time information regarding the RA procedure; and
transmitting the RA related information including the time information to a second network node of the wireless communication network;
wherein the time information comprises an indication of an elapsed time between the time the RA procedure was performed until the time the RA related information was transmitted to the second network node.

2-3. (canceled)

4. The method of claim 2, wherein the elapsed time is indicated as a number of minutes, a number of seconds, a number of milliseconds, a number of frames (e.g. radio frames or system frames), a number of subframes, a number of slots, a number of hours and a number of minutes, a number of hours and a number of minutes and a number of seconds, a number of minutes and a number of seconds, a number of seconds and a number of milliseconds, a number of minuets and a number of seconds and a number of milliseconds, or any combination of any of the above.

5. The method of claim 1, wherein the time information comprises a timestamp that indicates when the RA related information was logged.

6. The method of claim 1, wherein the time information comprises a timestamp that indicates when the RA procedure was performed.

7. The method of claim 5, wherein the timestamp is expressed as one of, or a combination of a UTC indication, a GNSS time indication, e.g. a GPS time indication, a Hyper-SFN (H-SFN) and a SFN, a H-SFN, a SFN and a subframe number, a H-SFN, a SFN and a slot number, a H-SFN, a SFN, a slot number and a symbol number.

8. The method of claim 1, wherein the time information comprises a timestamp that indicates a point in time when information related to the RA procedure was logged, the initiation of the RA procedure which the RA related information pertains to, a RA attempt, each RA attempt in the RA procedure which the RA related information pertains to, an end of the RA procedure, a last random access preamble transmission in the RA procedure, the reception of a random access response, RAR, or MsgB in a successful RA attempt, or the reception of a successful contention resolution indication.

9. The method of claim 1, wherein transmitting the RA related information including the time information to the second network node comprises including the time information in a RA-InformationCommon-r16 information element.

10. The method of any claim 1, wherein transmitting the RA related information to the second network node is performed in response to a request received from the second network node, wherein the request indicates that the time information should be included in the RA related information.

11. The method of claim 1, wherein the first network node and the second network node are the same network node.

12. The method of any claim 1, further comprising:
providing user data; and
forwarding the user data to a host via transmission to the second network node.

13. A user equipment comprising:
a processing circuitry;
a communication interface coupled to the processing circuitry; and
a memory coupled to the processing circuitry, wherein the memory comprises computer readable program instructions that, when executed by the processing circuitry, cause the user equipment to perform operations comprising:
performing a random access, RA, procedure towards a first network node of a wireless communication network;
logging RA related information regarding to RA procedure, the RA related information comprising time information regarding the RA procedure; and
transmitting the RA related information including the time information to a second network node of the wireless communication network;
wherein the time information comprises an indication of an elapsed time between the time the RA procedure was performed until the time the RA related information was transmitted to the second network node.

14. (canceled)

15. A method performed by a network node of a wireless communication network, comprising:
transmitting to a user equipment, UE, a request for a random access, RA, report from the UE;
receiving the RA report, wherein the RA report comprises time information regarding a RA procedure referenced in the RA report, wherein the time information comprises an indication of an elapsed time between the time the RA procedure was performed until the time the RA related information was transmitted to the second network node;
determining a time when the RA procedure referenced in the report was performed based on the time information;
identifying an RA configuration that was in effect at the time when the RA procedure referenced in the RA report was performed based on the time when the RA procedure referenced in the RA report was performed; and
adjusting an RA configuration parameter based on the RA report.

16-17. (canceled)

18. The method of claim 16, wherein the elapsed time is indicated as a number of minutes, a number of seconds, a number of milliseconds, a number of frames (e.g. radio frames or system frames), a number of subframes, a number of slots, a number of hours and a number of minutes, a number of hours and a number of minutes and a number of seconds, a number of minutes and a number of seconds, a number of seconds and a number of milliseconds, a number of minuets and a number of seconds and a number of milliseconds, or any combination of any of the above.

19. The method of claim 15, wherein the time information comprises a timestamp that indicates a time when information relating to the RA procedure was logged.

20. The method of claim 15, wherein the time information comprises a timestamp that indicates a time when the RA procedure was performed.

21. The method of claim 19, wherein the timestamp is expressed as one of, or a combination of a UTC indication, a GNSS time indication, e.g. a GPS time indication, a Hyper-SFN (H-SFN) and a SFN, a H-SFN, a SFN and a subframe number, a H-SFN, a SFN and a slot number, a H-SFN, a SFN, a slot number and a symbol number.

22. The method of claim 15, wherein the time information comprises a timestamp that indicates a point in time when information related to the RA procedure was logged, the initiation of the RA procedure which the RA related information pertains to, a RA attempt, each RA attempt in the RA procedure which the RA related information pertains to, an end of the RA procedure, a last random access preamble transmission in the RA procedure, the reception of a random access response, RAR, or MsgB in a successful RA attempt, or the reception of a successful contention resolution indication.

23. The method of claim 15, wherein the time information is included in a RA-InformationCommon-r16 information element.

24. The method of claim 15, further comprising transmitting a request for the RA report to the UE, wherein the request indicates that the time information should be included in the RA report.

25. (canceled)

26. A network node comprising:
a processing circuitry;
a communication interface coupled to the processing circuitry; and
a memory coupled to the processing circuitry, wherein the memory comprises computer readable program instructions that, when executed by the processing circuitry, cause the user equipment to perform operations comprising:
transmitting to a user equipment, UE, a request for a random access, RA, report from the UE;
receiving the RA report, wherein the RA report comprises time information regarding a RA procedure referenced in the RA report, wherein the time information comprises an indication of an elapsed time between the time the RA procedure was performed until the time the RA related information was transmitted to the second network node;
determining a time when the RA procedure referenced in the report was performed based on the time information;
identifying an RA configuration that was in effect at the time when the RA procedure referenced in the RA report was performed based on the time when the RA procedure referenced in the RA report was performed; and
adjusting an RA configuration parameter based on the RA report.

27-31. (canceled)
